(19) United States
(12) Patent Application Publication
(10) Pub. No.: US 2008/0040236 A1
(43) Pub. Date: Feb. 14, 2008

(54) System and method for ordering and producing a paper product with third party graphics printed thereon

(76) Inventor: Hideyuki Isowa, Kasugai-shi (JP)

Correspondence Address: BRINKS HOFER GILSON & LIONE, P.O. BOX 10395, CHICAGO, IL, 60610, US

(21) Appl. No.: 11/787,344

(22) Filed: Apr. 16, 2007

Related U.S. Application Data
(63) Continuation-in-part of application No. 11/409,550, filed on Apr. 20, 2006.

(51) Int. Cl. G06Q 30/00

(52) U.S. Cl. 705/26

(57) ABSTRACT

A system and method of selling free space on a printed sheet to a third party. A first party producer of the sheet, or box made therefrom, maintains a computer readable data base of second party orders for boxes having printable areas thereon, where one or more of the areas are available for use by third party printed matter. The third party may specify requirements for free space, which including characteristics of the free space, box characteristics, and time period of use of the box. The first party may accept orders for the free space on second party box orders, receives the images from the third party and print the images on a printed sheet using an ink jet printer.

### RELATED APPLICATIONS

This application is a continuation-in-part of U.S. application Ser. No. 11/409,550, filed on Apr. 20, 2006. This application is related to U.S. application Ser. No. 11/409,551, filed on Apr. 20, 2006, entitled “APPARATUS AND METHOD FOR PRINTING CORRUGATED CARDBOARD SHEETS”, and U.S. application Ser. No. 11/409,552, filed on Apr. 20, 2006, entitled “SYSTEM AND METHOD FOR ORDERING AND PRODUCING A MADE-TO-ORDER CORRUGATED PRODUCT” which are incorporated herein by reference.

### TECHNICAL FIELD

This application relates to system and method for ordering and producing paper products with printing thereon, and more specifically products where the image is specified by a third party.

### BACKGROUND

Public display advertising is used in the marketing and sale of many products to users. Such advertising may be displayed in billboards, placards mounted to the outside or inside of public busses, trains and the like, as well as posters affixed to walls, and the like. The geographical scope of coverage of these advertising means is ordinarily limited to the direct line of sight between the potential customer and the printed display medium. At best, the trains and busses cover a local geographic area. Such advertising means do not provide selectivity of the audience to which they are directed, except geographically, do not address customers who are known consumers of related products, and the number of views of each advertisement is not easily quantified.

A means of ordering and producing specifically targeted printed advertising which may be available for public viewing is needed. This advertising may be printed on sheets which may be displayed flat or folded to from a box.

Corrugated cardboard sheets or similar paper products intended for incorporation into packing or shipping boxes and containers may be printed by ink jet technology, as disclosed in the related U.S. patent applications mentioned above. Presently, two differing technologies may be used for ink jet printing. One technology is a thermal-type print head in which a bubble is formed inside a nozzle to eject the ink droplet toward the surface to be printed, and a second technology is a piezoelectric type in which the ink droplet is produced in response to the vibration of the ink orifice.

Where ink jet technology is used for printing a surface, such as the surface of a corrugated cardboard sheet used to form a box, the sheet width may be wide; as an example about 1500 mm. The ink jet printer for such widths may have a plurality of ink jet print heads, each ink jet print head having a plurality of ink jet nozzles oriented in a linear fashion. Such ink jet heads may have several rows of nozzles, each associated with a specific color, such as the ink colors yellow (Y), magenta (M), cyan (C), and black (K) as are used in a printing process.

The ink jet print heads are disposed in a widthwise direction so as to span the entire width of the surface to be printed. The jet print heads may be controlled by one or more process computers so as to eject the ink droplets at a time, with a color, and in a pattern so as to produce a desired image. The ink jet heads are fixed in position and the surface to be printed is advanced at a predetermined feeding rate so that the ink droplets can impinge thereon to form dots thereon and thus create the printed image.

The image data to be printed by the ink jet printer is provided to the printer controller in digital format. As such, multiple images may be transmitted for printing on various portions of the sheet corresponding to faces of a box. The images may be rapidly be replaced by new images to change the printing being produced. As such, printing may be adapted to customer requirements by changing the image data supplied to the process controller.

### SUMMARY

A system for producing a printed sheet is described, including a server computer configured to access a first data base of second party orders stored on a computer readable medium. The first data base includes free areas specified in the second party orders. The server may have a communications interface for receiving third-party-specified requirements for free areas, and the first data base is searchable to determine the specific second party orders meeting the third-party-specified free area requirements.

A method of accepting orders for printing on a free area of a sheet is described, the method including: providing a computer readable first data base of orders from a second party; searching the first data base using order characteristic criteria supplied by a third party over a communications interface; transmitting search results to the third party for orders in the first data base meeting the supplied order characteristic criteria; and accepting a third party order for printing on the free area of the sheet for one or more of the second party orders in the first data base.

A method of placing an order for printing on a free area of a sheet is described, the method including: requesting data regarding available free areas of sheets being produced for another; receiving data regarding available free areas of sheets being produced for another through a communications interface; selecting one or more of the available free areas; and placing an order for the printing of the free area.

### BRIEF DESCRIPTION OF THE DRAWINGS

FIG. 1 is a block diagram of the system, showing the first party equipment including the printing apparatus, the third party ordering station and the second party ordering station and a network connection;

FIG. 2 shows a representative image of a sheet for forming a box and having a free space area indicated thereon;

FIG. 3 shows a format for a computer monitor screen which may be used to express the third party free space and other requirements;

FIG. 4 shows a format for a computer monitor screen which may be used to display the results of a search made using the criteria shown in FIG. 3;

FIG. 5 shows a format for a computer monitor screen which may be used as a log-in and validating step in an ordering process; and

FIG. 6 shows images and data which may be displayed to a third party for a regular slotted container (a) and for a telescoping container (b).

FIG. 7 shows the data and material flows in a first method of selling advertising using the system of FIG. 1;

FIG. 8 shows the data and material flows in a second method of selling advertising using the system of FIG. 1;

FIG. 9 shows the data and material flows in a third method of selling advertising using the system of FIG. 1; FIG. 8 shows the data and material flows in a second method of selling advertising using the system of FIG. 1;

FIG. 10 shows the data and material flows in a fourth method of selling advertising using the system of FIG. 1;

FIG. 11 shows the data and material flows in a fifth method of selling advertising using the system of FIG. 1;

FIG. 12 shows the data and material flows in a sixth method of selling advertising using the system of FIG. 1;

FIG. 13 shows the data and material flows in a seventh method of selling advertising using the system of FIG. 1; and

FIG. 14 shows the data and material flows in a eighth method of selling advertising using the system of FIG. 1.

### DETAILED DESCRIPTION

Exemplary embodiments may be better understood with reference to the drawings, but these embodiments are not intended to be of a limiting nature. Like numbered elements in the same or different drawings perform equivalent functions.

A system and method for ordering and producing a paper product, which may be a corrugated paper sheet for forming into a box for packaging or shipping of an enclosed product is described, where at least a portion of the sheet corresponding to a face or surface of the box is printed with images selected and ordered by a third party. Generally, the term “third party” is intended to describe a business entity different from the producer of the printed paper sheet, or the sheet to be formed into a box (a “first” party), and the producer of the product to be shipped or stored in the box (a “second” party). In some instances, the third party may be part of the second party entity and may be using the box for a first product to advertise a second product, a service, or the like. Although the term “third party” is used for convenience in the discussion, there is not the intention to require that three independent business entities are unrelated to each other. Different persons, departments, or the like may equivalently be represented.

In many shipping and storage uses of a box or container, the box is manufactured with printed matter on one or more surfaces of the box. Such material is specified by the producer of the products to be contained in the box, and in the case of regulatory information, the producer of the box or the sheet to be formed into a box. Boxes may have printing on some or all of the exterior surfaces; however, in some instances not all of the sides of the box are printed, or not all of the sides of the box must necessarily be printed. Such a circumstance may provide for one or more box surfaces whose printed content may be specified by a third party, and be printed on the sheet from which the box is to be made, either at the same time as the second party printed material, or separately.

The costs of manufacturing the box, printing the box and other costs may be defrayed by selling the unused space on the box for the display of third party printed matter as advertising. Herein, a system and method of identifying opportunities for the use of unused space (“free space” or “free area” or “blank area”) of the surfaces of the box space, and facilitating the placement of orders for printing on such free space is disclosed.

In an aspect, the first party accepts orders for boxes from a second party. The specifications of the boxes ordered may include the size, configuration, liner material, color material, strength, and the like, and the second party, as the orderer, specifies the printed matter to be placed on the various surfaces of the box. To the extent that the second party wishes to participate in or authorize the use or sale of free space on boxes used for the products of the second party, one or more surfaces of the box are left blank, or the printing on one or more designated surfaces of the box may be replaced by advertising printed matter specified by a third party.

Systems and methods for ordering the box from the first party by the second party are described in the related applications mentioned, as well as a apparatus and method for producing the sheets to be formed into a box with a flexible printing process using ink jet technology. As a consequence of the ordering and producing of printed sheets for boxes, the order data base of the first party (the box producer) may contain information about the type of product to be shipped or stored in the box, the size and configuration of the box, identification of the corporate entity of the first party, production and shipping schedule, quantity ordered, and the like. Some or all of this information may be useful to a third party in identifying advertising opportunities.

In an aspect, the third party space requirements may be entered into a data base of the first party. These needs may specify the type or category of product or services to be advertised, the time period where the advertisement would be first available to the public, the number of boxes to be produced with the advertising material printed thereon or the total price or cost. As previously described, the first party is the producer of the printed sheet or box, the second party is the user of the sheet or box and the third party is the entity purchasing or specifying the content of the advertising space on the box, and placing the order for such space. The third party advertising requirements data base may then be compared with a multiplicity of orders placed by second parties to determine compatibility between the availability of space and the requirements of the third party. Where such compatibility exists, orders for use of the available free space for printing may be either automatically executed or the availability of space communicated to the third party so that a decision on placing an order may be made. Whether the space commitment is automatic or requires confirmation would be a customer preference specified in the second and third party information. As there is the possibility for commercial conflict in the placement of a third party advertisement on a box containing the product of a second party, the second party may require that a confirmation that the advertisement is acceptable be provided by the second party to the first party prior to acceptance of the order from the third party.

In another aspect, some or all of the information in the order data base that is relevant to the purchasing of advertising space may be made searchable by a third party. In this circumstance, the third party may access the data base by specifying parameters on a web page search form, or using a specially designed display format, so as to initiate a data base search of the order data base to identify records meeting the search criteria. The data base search engine may be any of the variety of such engines as are known in the art and may be found in web-based access applications. For commercial security, only known users having a valid user name and password may be provided with access to the order data base, and the connection between the first party and the second party order data base may be made through a server and using encrypted connections as are known in the art.

Instructions for managing the data bases at the several parties, the searching of the data bases, selection of advertising space, the ordering of advertising space and the manufacturing processes for producing the printed sheet for the box, and the like, may be provided on computer-readable storage media or memories, such as a cache, buffer, RAM, removable media, hard drive or other computer readable storage media, and executed by servers, computers or processors. The terms server, computer, processor and the like are used equivalently in the art and that practice is continued herein.

Computer readable storage media include various types of volatile and nonvolatile storage media. The functions, acts or tasks illustrated in the figures or described herein may be executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, data processing strategies may include multiprocessing, multitasking, parallel processing and the like. In an aspect, the instructions may be stored on a removable media device for reading by local or remote systems. In other aspects, the instructions may stored in a remote location for transfer through a computer network, a local or wide area network or over telephone lines. In yet other aspects, the instructions are stored within a given computer or system.

To support multiple users at geographically distributed locations, web-based applications and devices may be used. Where the term “web”, “network” or “Internet” is used, the intent is to describe an internetworking environment, which may include both local and wide area networks, where defined transmission protocols are used to facilitate communications between diverse, possibly geographically dispersed, entities. An example of such an environment is the world-wide-web (WWW) and the use of the TCP/IP data packet protocol, and the use of Ethernet or other hardware and software protocols for some of the data paths. The terms server, computer, processor and the like are used equivalently in the art and that practice is continued herein.

In the examples, the third party may also be considered to be a division or other business entity or staff organization of the second party having a need to place printed matter on boxes to be used for storage or shipment of products being manufactured by the second-party. The printed matter may relate, for example, to other products produced by the second party, to services provided in conjunction with the product to be enclosed in the box, or to other products, to special sales programs, discounts, new product announcements and the like. Each of these requirements may have time periods where the announcement is premature, such as before the product to be advertised has been publicly announced, and other time periods where the announcement is stale or out of date. Such criteria may form the basis for the search fields, along with information on the type, size, configuration and construction of the box which may be relevant to a decision on the placement of an image on the side thereof having free space.

As used herein, a corrugated sheet is intended to mean any structure having at least a liner and a corrugated structure, the liner and the corrugated structure being integral or co-joined by a fixation means such as an adhesive, an interlayer, or the like. Such corrugated sheets are commonly made from cellulose-based materials, but as used herein the term is not intended to exclude other materials such as plastics, staple fibers, or other combinations of materials that may be formed into sheets. A corrugated structure has a minimum of a liner and a corrugated structure, but may include multiple layers of each type and with various means of joining the layers together.

A sheet may be a corrugated sheet, a flat sheet, a flat sheet with a corrugated sheet affixed to one surface, a corrugated sheet having flat sheets affixed to opposing surfaces thereof, on combinations of such arrangements. The corrugations may be sinusoidal, crenellated, triangular or the like. The sheet may be cellulose-based, plastic, fibrous or the like and may be a combination of a variety of materials such that a surface suitable for printing is formed.

An image may include a picture, a drawing, a geometric or abstract design, including text, and be of one or more colors, and an image may consist of a single solid color. More than one image may be combined for printing on a surface or a face of the box or container.

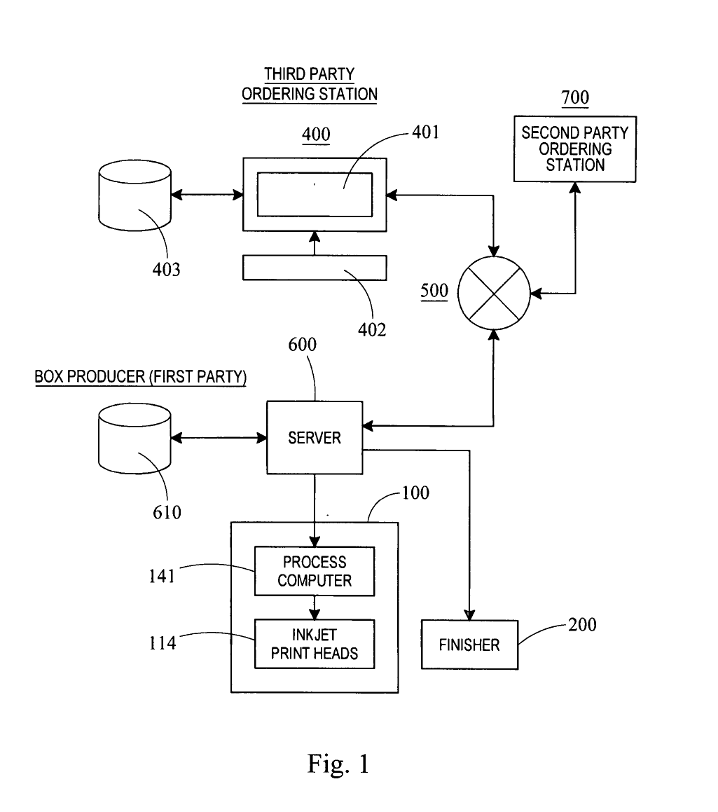

FIG. 1 illustrates a portion of the system and method, comprising a third party ordering station, which may also be termed a client or user, having a computer 400, interfacing with a communications network 500, the communications network 500 interfacing with the producer through a server 600. The computer 400, for use by the client may further comprise a display and central processing unit 401, a keyboard 402 and a mass storage medium 403. The computer may be a personal computer, or any equivalent thereof, and have a range of accessories (not shown) including a mouse, auxiliary storage, displays, and the like. The interface between the computer 400 and the network 500 may be a wired or wireless connection. The network may be any of a local area network (LAN), an intranet, a wide area network (WAN) such as the Internet, or a wireless interconnection, or a combination of any or all of the types of communications networks, so as to serve as a data connection between the customer and the producer.

The second party customer for the box, who may be a producer or distributor of the product to be stored and shipped in the box, may place an order for boxes through a second party ordering station 700, which has the same or similar capabilities as the third party ordering station which has been described. The second party places an order for boxes which may, specify size, configuration, construction details, quantity, and delivery date, in addition to the specific matter which is to be printed on the surfaces of the box. In the situation where one or more sides of the box, or the interior thereof is to be made available to a third party (where the third party may be an activity of the second party), such information as the location of the surfaces that are available, the type of product which will be contained in the box, the projected shipping date of the assembled box and product, acceptable types of third party printed matter, and the like may also be supplied. All or a subset of the information provided by the second party may be made available to the third party through a automated or interactive search of the second party order data base. The selection of the categories of information and the detail of the information to be provided regarding the order may be altered for third parties not associated with the second party. In addition, the access by a third party to the data base of orders maintained by the first party may be on a read-only basis.

At the producer location, a server or computer 600 has an interface to the network 500 and executes a compatible software protocol to establish and maintain communications with the client or user, which may be a second or a third party. A mass storage device 610, which may be any of the known types of memory, is connected to the server 600. The mass storage device may contain the data bases needed to perform the functions described herein, which may include the second party order data base for the boxes, a subset data base of the second party order data base which is accessible to third parties, a third party data base which may contain information as to specific needs of the third party for material to be printed on first party boxes, and a third party data base which contains orders for the printing of material on second party boxes. This may permit third-party specified advertising requirements to be compared with available space in the order data base on a requested or periodic basis in order to determine if the requirements can be fulfilled. Naming a data base does not imply that the data may not be stored in a composite data base where individual fields have specified access restrictions, the merging of data bases, the querying of multiple data bases, and the like.

Naming of the data base is convenient for discussing some functional aspects as may be perceived by a person, but is not intended to suggest a limitation on the way in which the actual data is stored and processed.

The server 600 further interfaces with an ink jet printer 100, the ink jet printer having a print controller 141. A control signal is transmitted from the server 600 to the ink jet printer 100. This may include the conversion of red (R), green (G), blue (B) data representations normally used to display images on a visual display such as a computer monitor to the yellow (Y), magenta (M), cyan (C) and black (K) format which may be used for printing. Alternatively, the representations may be converted in the print controller 141. A finisher 200, which may be comprised of a creaser and a slotter may be connected to the server 600. Alternatively the server may display or print instructions for operators regarding the operation of the finisher 200, and the steps needed to perform the setup and the operation of the finisher may be performed either manually or automatically.

In an aspect, the printed image including the image specified by the second party and the image for the free area specified by the third party may be printed on the sheet in one printing operation, or only the image specified by the third party may be printed on the free area of the sheet on which the image specified by the second party may have already been printed.

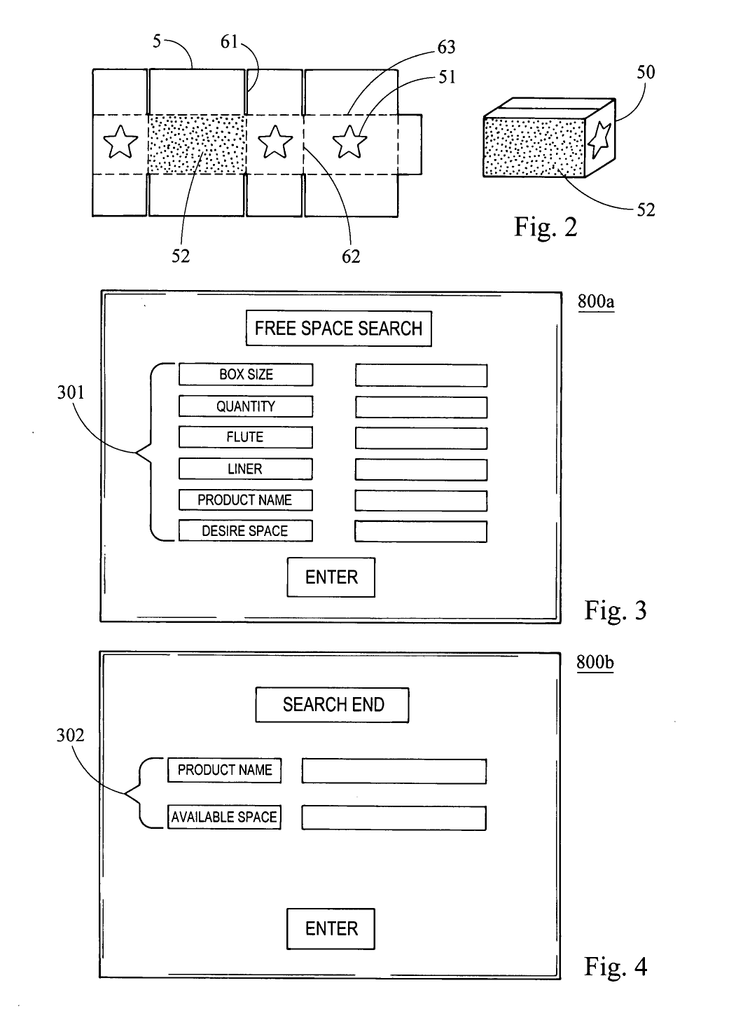

FIG. 2 is an example of a box whose characteristics are maintained in the first party order data base, showing a box having three sides where the printing has been specified by the second party as the user of the box, and shown schematically by stars 51, and a side where the second party may permit a printed message or image to be inserted by a third party shown as a lined area 52. For example, in a case where the products to be shipped by the box are apples produced by the second party, stars 51 may be an image of the apple, while the printed message for the free area 52 may be related to an apple jam produced by the third party. The box is shown both in the form of the sheet 5 that will be produced by the first party, including slots 61, creases 62 and scores 64, as well as a perspective view of a completely assembled box 50.

FIG. 3 is an example of a computer monitor screen 800a which may be used by the third party to query the order data base to determine whether suitable space is available. This query may be performed by manually entering the information on the screen, or by storing space requirement information in a third party data base on the mass storage medium 610 so that the query may be run multiple times until either the time period specified by the third party has expired or the space requirement is fulfilled. In the examples presented, a manually controlled search is described, but an automatic search performing at least the functions described is equally possible.

The third party ordering station screen 401, may have a variety of different and customizable search field inputs which may be particular to the needs of the third party. Only a sample of such search fields are shown herein, and which may include box size, quantity, characteristics such as flute and liner, product type, amount of space desired and time period of availability. Other search criteria have been mentioned in this specification, and the choice of such criteria may depend on the users, the industry of the products, and the like. The search may be initiated by clicking on an enter button, pressing the enter key or return key on the keyboard 402, or any similarly acting input device or method. The search request is sent from the ordering station 400 to the server 600 over a network 500, which may be the Internet, a LAN, a WAN, a wireless connection or the like, so that the ordering station 400 and the server 600 may not be co-located.

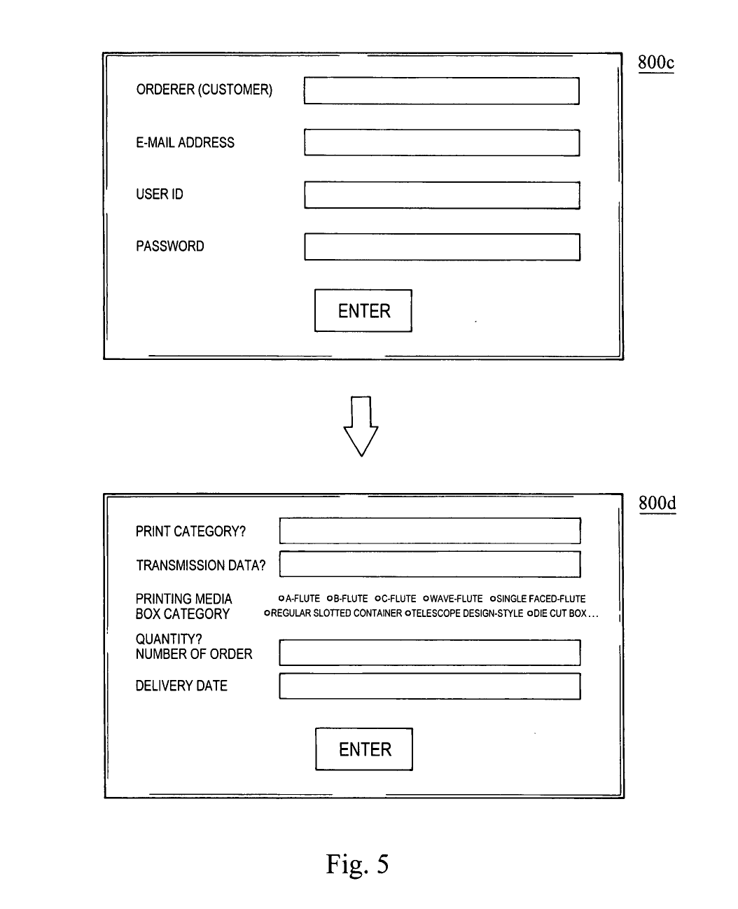

Upon receipt of the search request, the server 600 performs the functions of searching the appropriate data bases stored on mass storage medium 610 and formats the results of the search for transmission over the network 500 to be displayed at the ordering station 400 on the display 401.

Where the search returns one or more second party orders which are suitable for the purposes of the third party and which may be displayed on a search results screen 800b, as shown in FIG. 4, an order may be placed for the printing on the free space 52. In placing such an order, it may be required that the third party user access a log-in screen 800c as shown in FIG. 5, where such identifying information as customer number, user ID and password are required. Such information is then sent over the network to be validated by the server 600, and an ordering screen having ordering information 800d presented to the user. All of the information may be entered manually, however as the results of the search may have presented much of the information needed to complete the ordering process, such information may be entered automatically on the form, subject to validation or change by the user.

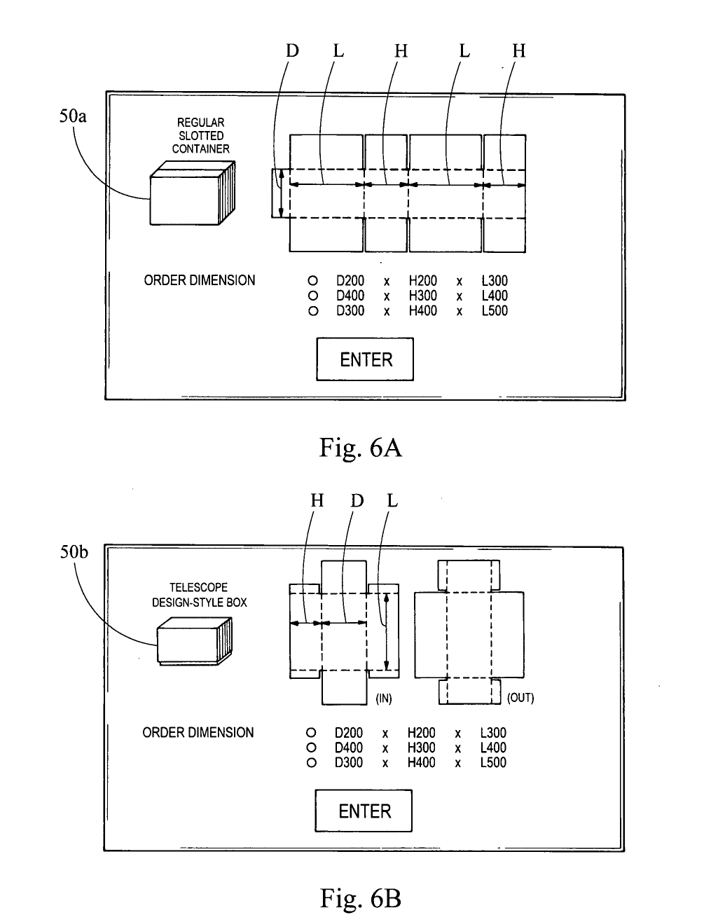

As part of the search and decision making process, the ordering station 400 may display representations of the sheet and box type available, and may also indicate the surface of the box where third-party-ordered printing may be placed. FIG. 6 a shows a developed outline image of a regular slotted storage container 50a where the available dimensions are indicated. Similarly, a telescoping design style box 50b is shown in FIG. 6b. In this example, the box is produced in two pieces, where the cover of the box is sized and dimensioned to fit over the remainder of the box to form a top closure. Other box styles may be similarly displayed so that the user may visualize the configuration, however, the user may order the printing without the need to display an image such as the developed outline image.

A method for accepting orders for printing on a free area or space of a box or shipping container includes: establishing and maintaining a data base of second party orders for boxes, including at least the identification of one or more areas of the box which may be available for printing of information or images specified by a third party; accepting requests from a third party seeking to order the printing of images on free areas of second party boxes; searching the data base of second party orders so as to identify second party orders meeting the third party ordering criteria; transmitting the information relating to available free areas meeting the search criteria to the third party; and receiving an order for printing from the third party.

A method of ordering printing of third party supplied information or images on a free area of a shipping container ordered by a second party includes: formulating a search request incorporating ordering criteria, which may include but is not limited to: type of box, quantity of boxes, shipping date, and the like; forwarding the search request to a first party capable of providing the service of searching box orders for available free area meeting the search criteria; receiving search results indicating the second party orders having free areas meeting the search criteria; displaying the search results; selecting a search result meeting third-party requirements; and, placing the order by validating, modifying or filling out an order form of the display.

The subsequent steps of the manufacturing process may be performed automatically, manually, or by a combination of automatic and manual steps.

In each of the methods, at least one of initiating the searching, the selecting of first party orders for which a third party order for free space is to be associated with, or the third party order placement, may be performed automatically. Further, here, as in the discussion of the system, there may be more that one first party, second party and third party. The first party may be an intermediary between the box printer (as the producer first party) and the second and third party. The intermediary may be an advertising agency or advertising sales bureau, which may offer the free space on boxes of more than one box printer (first party) and product manufacturer (second party) to third parties.

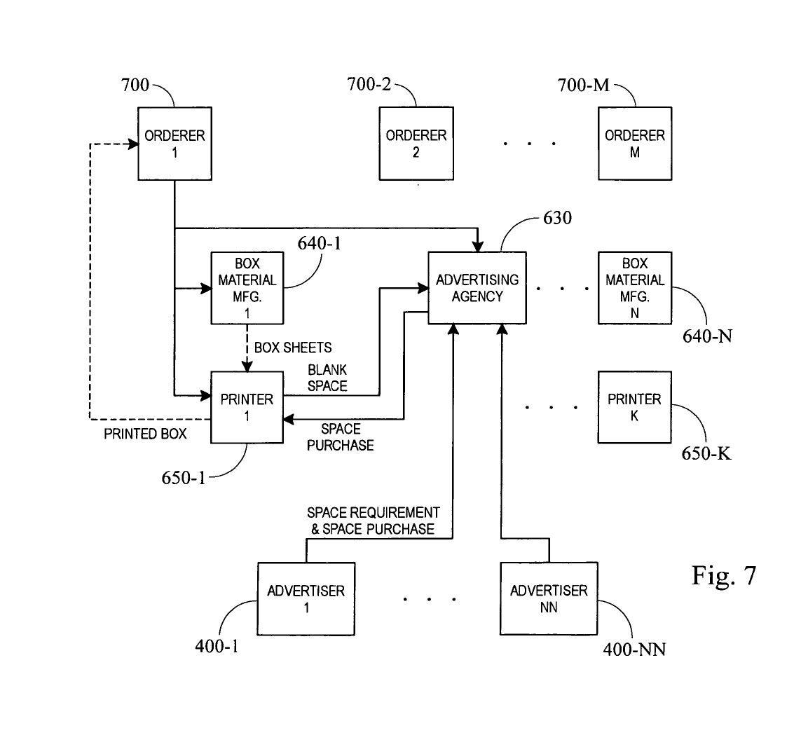

In an aspect, the system of FIG. 1 may be used in a distributed fashion by a multiplicity of parties having attributes of being orderers of boxes, or materials for boxes, producers of the boxes or materials for boxes, printers having the capability to produce bulk printing, short run printing, or both, advertising agencies, and advertisers. As shown in FIG. 7, the second party 700 may correspond to a producer or distributor of a product requiring a box to protect and store the product during shipment and desiring to sell, or have sold, blank areas on the box to third parties, for compatible advertising material. The third party advertiser 400 may be a plurality of individual entities, each having distinct and independent needs for advertising that may be printed on boxes having available blank space. The first party 600 box producer may include a plurality of entities performing functions needed to satisfy the requirements of the plurality of second parties 700 and the plurality of the third parties 400.

The first party 600 may include a manufacturer of box materials 640, such as corrugated sheets, a printer for printing 650 the box material with information and images supplied by at least one of second party 700 or the third party 400, and an advertising agency 630 which may serve as an intermediary between the entities comprising the first party 600, and the second and third parties. The printer 650 entity may be more than one type of printer type. That is, a printing entity may specialize in bulk printing using rotary presses, or the like, or may specialize in short-run printing using, for example, an ink jet printer. Some printers 650 may have the capability to perform both types of printing process.

The term “rotary press” may be used to represent an entity having a capability to print large quantities of sheets with the same image and data, and the term “ink jet printer” may be used to represent an entity having a capability to print sheets with images which may be changed from sheet-to-sheet, or at least be economically done in small quantities. That is the term, for example, rotary press, may represent the actual printing press, the functional capability of the printing machine, or the business of the entity.

FIG. 7 illustrates a first example of a configuration of entities engaged in the production, configuration and use of printed materials, which may be the cardboard sheets for forming a box. Here, there are a multiplicity of users placing orders for cardboard boxes, a plurality of box manufacturers producing the cardboard sheets in accordance with the specifications selected by the orderer, a printer to print information and images on at least a portion of the visible surface of the box to be formed from the sheet, an advertising agency serving as an intermediary between an advertiser and the remainder of the entities. Solid arrows between entities indicate data, information or image flow. Generally information flow between entities is bi-directional, however, the arrow head shows the flow needed to provide the information needed for the principal functions to be performed. Dashed arrows between entities indicates the flow of material such as a cardboard sheet.

A user or orderer 700a, which may be an entity producing the product to be shipped in the box, places an order for boxes with a box manufacturer 640a, which may be one of a plurality of box manufacturers 640. Placement of the order with a particular box manufacturer may be as a result of commercial considerations such as price, delivery, quality and the like. The information furnished by the user 700a may include box type and material specifications, box dimensions, quantity and delivery. The user 700a may select a printer from a plurality of printers 650, and place an order for printing the boxes ordered from the box manufacturer 640a with a printer 650a, which be selected using similar commercial criteria as used to select a box manufacturer. Information furnished to the printer 650a may include the information and images to be printed on the box, the surfaces to be printed, and any surfaces that are blank, and which may be available for advertising by an advertiser 400.

Information on the availability of blank areas 52, including the quantity, size, and projected utilization date, and the contents of the box when used to ship or store the user product may be furnished by the printer 650a to an advertising agency 630, which may be a separate entity, or be a functional aspect of the printer 650. Here, the advertising agency 630 is shown to be an independent entity and is in communication with a plurality of printer entities 640. For example, printers 650a and 650b may cooperate with advertising agency 630 by sending information available to each of the printers 640a and 650b based on orders and information received from a plurality of unrelated orderers 700a, b, c.

An advertising agency 630 may manage a data base of information received from the plurality of printers 650 so as to maintain current information on the availability and characteristics of blank space available for the printing of advertising material. This data base of available blank space may be searched by the advertising agency 630 based on requests from one or more advertisers 400 a . . . n. Alternatively, the advertisers may be permitted to search the data base of the advertising agency 630, depending on the business practice of the advertising agency 630, and taking account of any restrictions on access placed on the information by the printer or the orderer. Such access may be password protected, and may be limited to a subset of the information in the data base, including a subset of the information related to each orderer 700 a, b, c.

Based on the searching of the data base of the advertising agency 630, one or more advertisers 400 may place orders with the advertising agency 630 for information and images to be printed on the blank areas 52 of the printed sheets being produced for boxes by the printers 650. Such orders are sent to the printer 650 producing the specific order for which the blank space has been purchased. The various exchanges of formal paperwork or data between the parties for accepting an order, billing, and confirming shipment and receipt, as well as other commercial aspects of the transaction that have not been described, are not specific to the transaction types being described herein, and are known to persons of skill in the art.

When the printer 650 receives an order from the advertising agency for printing on blank spaces in one of the orders received from an orderer 700, the information and images are linked to the order from the orderer 700. When the boxes associated with the order are received from the box manufacturer 640, the printing job may be scheduled by the printer 650, and the printed box sheets or assembled boxes sent to the orderer 700 that had placed the order. Depending on the printing modality being used, the bulk printing of images may be performed by a rotary press or an ink jet printer, or the like, and the printed sheets with blank space remaining may be moved to temporary storage or to the next printing process, which may be a short run printing process using an ink jet printer, or the like.

The term “short run” is not intended to restrict the number of sheets being printed to less than the total number of sheets in the order, although this may occur. Rather, “short run” indicates that the image or information being printed may have the characteristic that the type of printing modality used permits the image to be changed from sheet-to-sheet. However, the image and information is produced in accordance for the order for printing on the blank area, and may be of the quantity specified in the order for printing on the blank sheet, which may be less than or equal to the total quantity of sheets printed.

The orderer 700, the advertising agency 630, the box manufacturer 640, the printer 650, and the purchaser of blank space 400 may have specific business relationships with each other, such as being part of the same economic group, or be independent of each other, and select each other as suppliers on an “arms-length” basis determined only by convenience and economic factors. As such, a variety of configurations of the entities and data and material flows are possible.

Several variations of the configuration of FIG. 7 are discussed, but these are not intended to limit the relationships between the parties, or to suggest that the information and material flow is limited to the paths and information specifically described. Generally, at least one of the functional parties is at a separate location from the others, and information is transferred by a variety of means, which include local area networks, or wide area networks, which may include the Internet. Other forms of information transfer may be used including writing the material to a non-volatile media such as a CD-ROM, DVD, flash memory, or the like, or using audio or written communication for a part of the transaction. Electronic transfer of data for the transaction may be limited by the facilities at each of the participants.

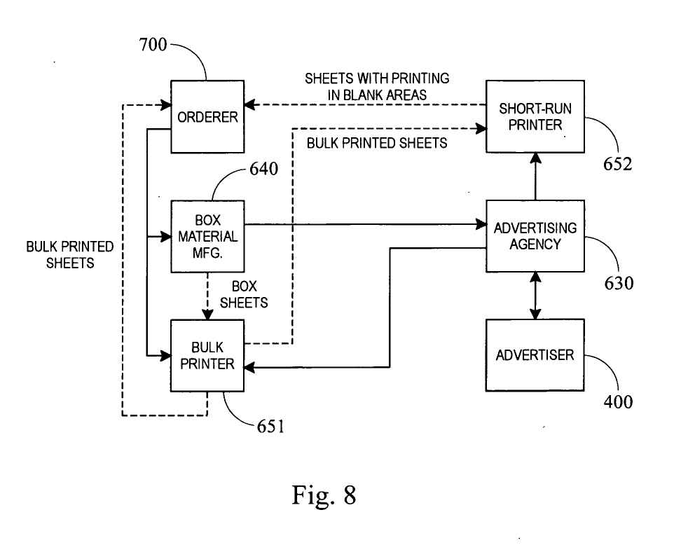

FIG. 8 shows a configuration, data and material flow where the advertising agency 630 also performs the short-run printing. In this example, the orderer 700 places an order for boxes with a box manufacturer 640, and an order for bulk printing with a printer 651, where the printer 651 is a printer 650 having a rotary or similar press which may be used for bulk production runs having the same information or images to be printed on the sheets being ordered. The box manufacturer 640 delivers the sheets to be printed to the printer 651. The printer 651 makes the availability of blank spaces on boxes known to the advertising agency 630. The information provided may include information on the type of product that will be on the box, the type of advertising that may be suitable for the blank area, and the like. The advertising agency 630 includes the information from the printer 651 in a data base indicating availability, and the space may be purchased by any of the methods previously described. The quantity of printed box sheets purchased by the advertising agency 630 from the printer 651 are shipped from the printer 651 to the advertising agency 630, and the advertising agency may have a printer 652, which is a short run printer such as an ink jet printer which may be used to print the advertising material on the blank surface of the box sheet. The printer 652 may be a part of the advertising agency, or may be a separate entity. Once the box sheets have been printed by the short-run printer 652, they are shipped to the orderer 700, completing at least part of the order.

When the amount of advertising purchased by the advertising agency 630 does not require the entirety of the order placed by the orderer 700 to be printed with the advertising material, the residual sheets may be shipped directly from the printer 651 to the orderer 700. Alternatively, the printer 651, may adjust the data base record relating to the remaining number of sheets having blank space available for the order and make that adjusted data available to one or more advertising agencies 630. This process may be repeated until such time as the order has to be produced and shipped, or all of the blank space for the order has been allocated to advertisers. In this way a plurality of advertisers may place advertisements on portions of each order of boxes. Since the bulk printer 651 is configured to print a large quantity of boxes with the same information, the short-run printer 652, which may be associated with the advertising agency 630, may represent a method of matching the advertiser quantity needs and availability time with the available blank space.

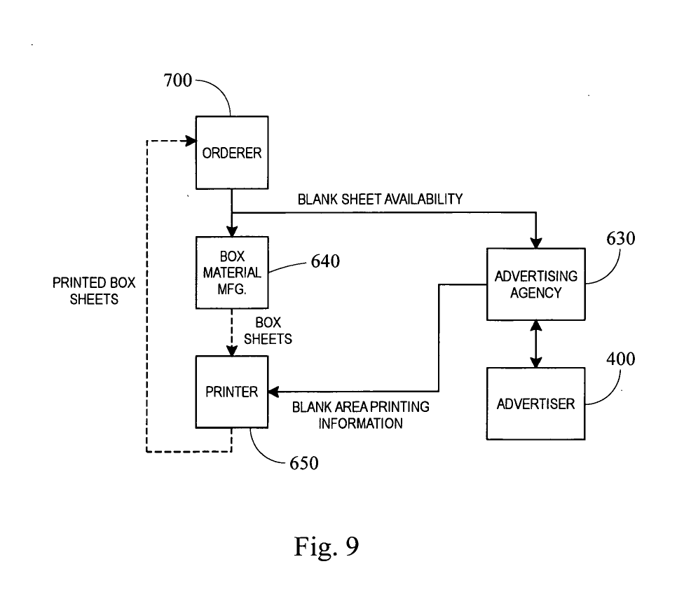

In another example, shown in FIG. 9, the advertising agency 630 is responsible for choosing the printer 650, which may be a single printer, or a combination of a bulk printer 651 and a short-run printer 652. The orderer 700 places an order for box sheet material with a manufacturer 640 of box sheet material for the type, size and quantity of box sheet material needed. An order for the printing is placed with the advertising agency 630, including the quantity to be printed and other related information, has previously described. As such, the information provided to the advertising agency 630 by the orderer 700 now includes information that may have been provided to the advertising agency 630, in previous examples, by the printer 650 and the orderer 700. The advertising agency 630 may now choose a printer 650 based on commercial considerations and place an order for printing. At the time of placement of the order with the printer 650, the advertising agency may include information only regarding the bulk printing, or for the bulk printing and any printing that has been placed by the advertising agency 630 for printing on the blank areas identified by the orderer 700. In this manner, the advertising for the blank areas of the printed sheet may not be committed when the bulk printing order is placed. The information to be printed on the blank areas may be consolidated and sent to the printer 650 at one time, or released in smaller quantities. In an aspect, the short-run printing may be performed by another printer 652 and the information to be printed is sent to the short-run printer 652 in a either consolidated form or incrementally.

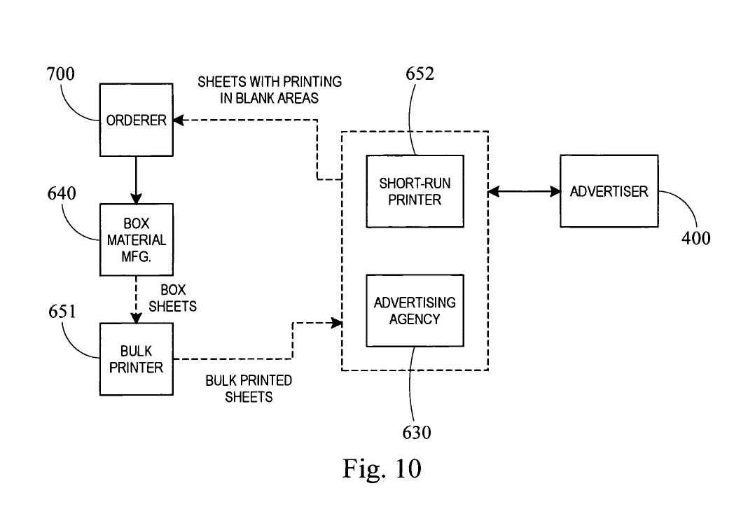

In another aspect, FIG. 10 shows a relationship where the orderer 700 provides separate orders to the box manufacturer 640 and the bulk printer 651, and also sends information to the advertising agency 630, for inclusion in a data base of available blank space for sale to advertisers 400. The material flow is from the box sheet manufacturer 640 to the bulk printer 651, where the printing ordered by the orderer 700 is performed. The bulk printed sheets are sent to the short-run printer 652, which may be a part of the advertising agency 630 or a separate short-run printer 652. The short-run printer 652 may print the advertising information provided by the advertising agency 630 in the blank areas of the box sheets may send the completed sheets to the orderer 700. The process for identifying the blank areas on the box sheets, interacting with potential advertisers to sell the space, and the management of the printers is similar to that previously described.

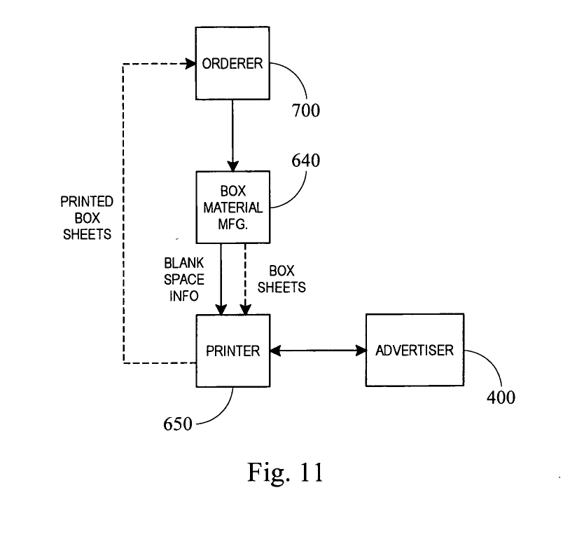

In yet another aspect, FIG. 11 shows a relationship where the orderer 700 places the order for the box sheets with a box manufacturer 640 and, in addition to the information need to produce the sheets, the bulk printing requirements, including the identification of the blank spaces available to advertisers 400 is provided. The box manufacturer 640 may select a printer 650, having the capability for bulk printing and short-run printing or separate printers having specific capabilities, and provide the printing information to the printers selected. The information may be provided at any time prior to the printing of the sheets, and may be provided in advance of shipment of the box sheets. Potential advertisers make space needs available to the printer 650, and the printer 650 matches the space requirements of the advertisers 400 with the space The advertisers 400 may place orders for advertising material to be printed on the blank areas offered by the printer 650, and the printing scheduled to accommodate the receipt of the box sheets from the box manufacturer 640 and the overall delivery schedule. Advertising may be sold for printing contemporaneously with the bulk printing, or the bulk printed sheet may be delivered to the orderer 700 as required, and with advertising printed on the blank areas, providing that that the printer has sold the advertising space. Incremental printing of batches of an order, and incremental shipping of box sheets by the box manufacturer 640 to the printer 650 may accommodate “just-in-time” business methods, so that the amount of material in storage between the various process is either minimized, or adapted to the economics of each of the manufacturing or printing processes.

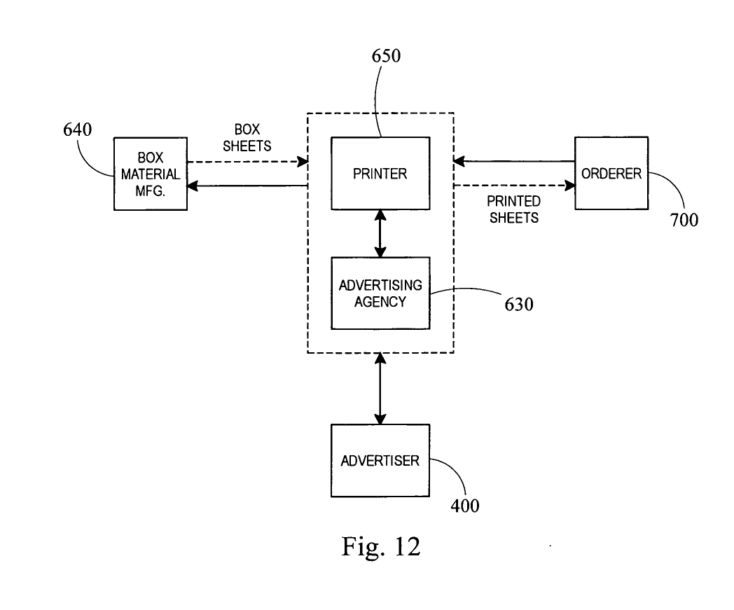

In yet another aspect, shown in FIG. 12, the printer 650 also acts as an advertising agency 630. The orderer 700 places an order for a printed sheet for use in a box, the order including blank space information, the information and images to be printed on the sheet, blank space identification, and specifications for the sheet. The printer may order the sheet from a corrugated box manufacturer 640, and place the information on availability of blank space in a data base of an advertising agency 630 associated with the printer 650. The advertising agency 630 may distribute or otherwise make available the information regarding blank space availability to an advertiser 700. The advertisers 700 may be a plurality of independent entities, as in the previous examples. When the order is scheduled to be printed by the printer 650, the order may be bulk printed and short-run printed in accordance with the procedures of the printer 650, and shipped to the orderer 700.

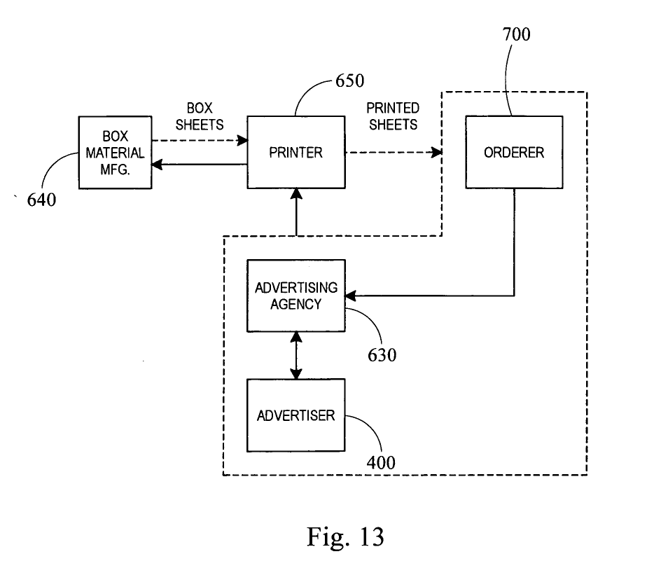

In still another aspect, shown in FIG. 13, the advertising agency 630 may be associated with the orderer 700. This may occur, for example, in a enterprise with several divisions or associated companies where the products of one business of the organization may be advertised on boxes being used to ship products of another of the businesses of the organization. Here, the orderer 700, the advertising agency 630 and the advertiser 700 may be functional aspects of a business. There may be a number of business entities that perform the function of advertisers in this model. An advertising agency of this type may be known as an “in-house” or captive agency. Such a model may be used to allocate the costs of advertising to the portion of the business placing the advertisement for printing on blank spaces. The advertising agency 630 may place the order for printed box sheets with a printer 650 and the printer may order suitable box sheets from a corrugated box manufacturer 640. The ordered box sheets may be delivered to the printer 650, printed, and then delivered to the orderer 700.

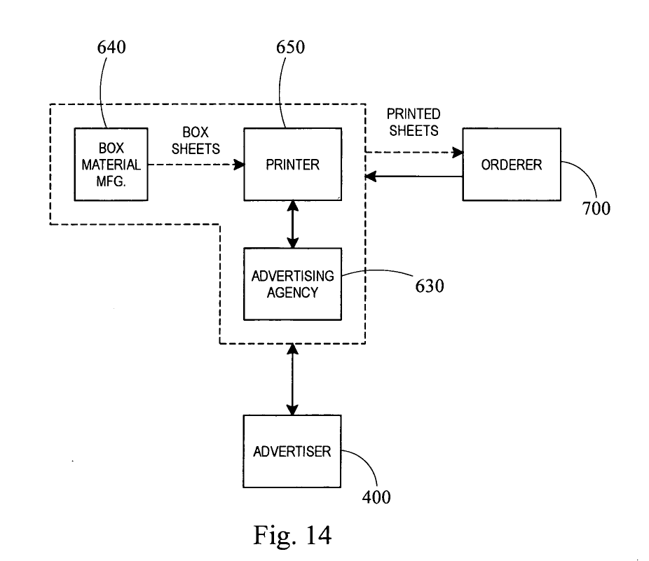

In a further aspect, shown in FIG. 14, the functions of the printer 650, box manufacturer 640 and advertising agency 630 may be associated with the same organization, business entity, or associated business entities. An order is placed with the printer 650 by the orderer 700. The requirements are distributed to the box manufacturer 640 entity and the advertising agency 630 entity. The advertising agency entity 630 undertakes to sell blank space that has been identified by the orderer 700 by interacting with a plurality of potential advertisers 400 by identifying the available blank space and the parameters affecting the availability of the space to the advertisers 400. The various criteria for selecting space and selling the space have previously been described.

When space has been sold by the advertising agency 630, the information is provided to the printer 650 so as to be merged with the data file representing the order and to permit the use of the blank space on the box sheets of the order for printing the sold advertising material. In this regard, the sequence of printing, and whether the whole order is printed at once or piecemeal, is subject to the same business decision methodology as has previously been described.

While the methods disclosed herein have been described and shown with reference to particular steps performed in a particular order, it will be understood that these steps may be combined, sub-divided, or reordered to from an equivalent method without departing from the teachings of the present invention. Accordingly, unless specifically required herein, the order and grouping of steps is not a limitation of the present invention.

Although only a few exemplary embodiments have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

1.-17. (canceled)

18. A method of ordering a box, the method comprising:
a first party placing an order with a second party for a box having printed material on one or more surfaces thereof, the order
designating a blank area where third-party advertising is printable.

19. The method of claim 18, further comprising:
providing information to the second party representing a type of product to be contained in the box, and at least one of subject matter of third party advertising that can be printed, or subject matter of third party advertisements that cannot be printed.

20. The method of claim 18, further comprising receiving compensation from the second party for the third party advertising.

21. The method of claim 18, further comprising:
providing information to an advertising agency representing a type of product to be contained in the box, and at least one of subject matter of third party advertising that can be printed, or subject matter of third party advertisements that cannot be printed.

22. The method of claim 21, further comprising receiving compensation from the advertising agency for third party advertising.

23. The method of claim 19, where the compensation is monetary.

24. The method of claim 18, wherein the blank area is a portion of a side of the box.

25. A method of advertising, the method comprising:
a first party receiving data from another party describing blank space availability for printed sheets;
the first party ordering printing from a second party based on blank space requirements of a third party; and
the first party updating the database based on the ordered printing.

26. The method of claim 25, wherein the first party sends data relating to blank space availability to the third party and receives an order from the third party for blank space, selected from the available blank space, to be ordered from the second party.

27. The method of claim 25, further comprising:
receiving information on third party advertising space requirements;
searching the database of blank space availability and sending information on blank space of the available blank space meeting the advertising space requirements to the third party; and
receiving an order for advertising content to be printed in the blank space from the third party.

28. The method of claim 25, wherein the second party has a capability for bulk printing and for short-run printing.

29. The method of claim 28 wherein the method of bulk printing is a rotary printing press.

30. The method of claim 28, wherein the method of short-run printing is an ink jet printer.

31. The method of claim 25, further comprising the first party printing advertising content on the blank space using a short-run printer.

32. The method of claim 25, further comprising ordering printing from the second party based on a third party order, the printing to be performed a short-run printer.

33. The method of claim 25, wherein the first party and the second party are the same party.

34. The method of claim 25, wherein data describing blank space availability is received from the another party by modulating the data on a carrier wave.

35. The method of claim 25, wherein data describing blank space availability is transmitted from the another party to the first party using the Internet.

36. The method of claim 25, wherein the database is maintained on a machine-readable medium and managed by a computer configured to manage the database.

37. The method of claim 25, wherein the data describing blank space availability includes a size of the blank area, and at least one of the following:
a location of the blank space on a box fabricated using the printed sheets;
a quantity of sheets having the blank space;
a description of the type of product to be placed in the box;
a description of at least one of a type of product that is advertisable by printing information in the blank area, or a type of product which is not advertisable by printing information in the blank area;
an accessibility date when the box having information printed in the blank space is expected to be publicly viewable;
box specifications including at least one of a type, a size, external sheet color and ink characteristics, or interior sheet color and ink characteristics; or
a cost for printing the advertiser information on the blank space.

38. The method of claim 25, wherein the another party is one of a purchaser of printed box sheets or boxes, a printer of boxes using at least a bulk printing method, or a manufacturer of box sheets.

39. A method of advertising on boxes, the method comprising:
transmitting information on advertising space requirements for advertising to be printed on a blank space of a box to an advertising agency;
receiving information on blank space availability meeting at least a portion of the advertising space requirements from the advertising agency; and
ordering selecting blank space from the blank space availability, information, for advertising content to be printed on the available blank area of a box, the box being produced for containing a first product differing from a second product or a service described in the ordered advertising space.

40. A method advertising space boxes, the method comprising:
receiving information on the availability of blank space on a surface portion of a box suitable for the printing of advertising content, and maintaining a data base of the information on a machine readable medium;
receiving requests for blank space;
searching for the data base for blank space meeting the requests;
transmitting the information relating to blank space meeting the request to the requester.

41. The method of claim 40, further comprising receiving an order for printing of advertising content in response to the transmitted information, and placing an order for the printing of the advertising content with a printer.

42. The method of claim 40, wherein the information on the availability of blank space is received from the printer.

43. The method of claim 40, wherein information on the availability of the blank space is received from the box purchaser.

44. The method of claim 40, wherein information on the availability of the blank space is received from the box manufacturer.

45. A method of procuring a box having third party advertising printed thereon, the method comprising:
placing an order for a box;
identifying a blank space on the box suitable for third party advertising;
transmitting the information on the blank space to one of an advertising agency, a printer, or a box manufacturer.

46. The method of claim 45, further comprising:
receiving compensation for third party advertising printed on the box.

47. The method of claim 45, wherein the placing an order further comprises:
at least one of selecting a box supplier, or selecting a printer, wherein the printer has at least the capability for bulk printing.

48. The method of claim 47, wherein the advertising agency is a function of an entity placing the order for the box.

49. The method of claim 45, wherein the blank space information is transmitted using digital data.

50. The method of claim 49, wherein the digital data is modulated on a carrier wave.

51. A method of advertising, the method comprising:
receiving data describing blank space availability for printed sheets;
maintaining a database including blank space availability;
ordering printing of advertising content on blank space selected from the available blank space; and
updating the database based on the ordered printing.

52. A method for producing a corrugated cardboard sheet which can be formed into a container, the method comprising:
maintaining a first database of a plurality of second party orders for corrugated cardboard sheet, at least one of the second party orders prescribing the printing of a second party image thereon, and at least a free printing area available for the printing of an image specified by a third party;
accepting third party information suitable for searching the first database of the plurality of second party orders;
receiving a request from the third party for printing the image specified by the third party on the free printing area of a cardboard sheet of at least one of the second party orders;
accepting the request from the third party; and
printing the image specified by the third party on the free printing area of the cardboard sheet of at least one of the second party orders.

53. The method of claim 52, wherein the printing of the image specified by the third party is performed by an inkjet printer.

54. The method of claim 53 wherein the image specified by the third party is printed at or about the same time as the printing of the second party image.

55. The method of claim 53, wherein the image specified by the third party is printed subsequent to the printing of the second party image.

56. The method of claim 52, wherein the method further comprises:
maintaining a second database of third party information, the third party information being used as the basis for the searching of the first database.

57. The method of claim 56, wherein the image specified by the third party is printed at or about the same time as the printing of the second party image.

58. The method of claim 56, wherein the image specified by the third party is printed subsequent to the printing of the second party image.
